(19) United States
(12) Patent Application Publication
(10) Pub. No.: US 2017/0105006 A1
(43) Pub. Date: Apr. 13, 2017

(54) Method and Apparatus for Video Coding Using Master-Slave Prediction Structure

(71) Applicant: MEDIATEK INC., Hsin-Chu (TW)

(72) Inventors: Hung-Chih LIN, Caotun Township (TW); Shen-Kai CHANG, Zhubei City (TW)

(21) Appl. No.: 15/354,162

(22) Filed: Nov. 17, 2016

Related U.S. Application Data
(63) Continuation-in-part of application No. 15/289,092, filed on Oct. 7, 2016.
(60) Provisional application No. 62/266,763, filed on Dec. 14, 2015.
(60) Provisional application No. 62/266,764, filed on Dec. 14, 2015.
(60) Provisional application No. 62/240,693, filed on Oct. 13, 2015.

(51) Int. Cl. H04N 19/159; H04N 19/61; H04N 19/15; H04N 19/513; H04N 19/117; H04N 19/105; H04N 19/124

(52) U.S. Cl. CPC H04N 19/159; H04N 19/105; H04N 19/61; H04N 19/124; H04N 19/513; H04N 19/117; H04N 19/15; H04N 19/172

(57) ABSTRACT

A method and apparatus of video coding are disclosed. At the encoder side, if the current input picture is designated as a master picture, the current input picture is down-sampled to a current down-sampled picture and the current down-sampled picture is encoded using an Intra mode or an Inter mode. The current down-sampled picture only uses one or more previous reconstructed down-sampled pictures as one or more first reference pictures if coding blocks of the current down-sampled picture are coded using the Inter mode. If the current input picture is designated as a slave picture, coding blocks of the current input picture are encoded with the Inter mode by up-sampling one or more previous reconstructed down-sampled pictures and only using pixel data with one or more up-sampled pictures corresponding to said one or more up-sampled pictures as one or more second reference pictures. A corresponding decoder is also disclosed.

### CROSS REFERENCE TO RELATED APPLICATIONS

The present invention claims priority to U.S. Provisional Application No. 62/266,763, filed on Dec. 14, 2015, and the present invention is also a Continuation-In-Part of U.S. patent application Ser. No. 15/289,092, filed on Oct. 7, 2016, which claims the priority to U.S. Provisional Application No. 62/240,693, filed on Oct. 13, 2015, and No. 62/266,764, filed on Dec. 14, 2015, which are hereby incorporated by reference in the entirety.

### FIELD OF THE INVENTION

The present invention relates to video coding using Master-Slave prediction structure. In particular, the present invention relates to method and apparatus to reduce coding complexity and bitrate for coding systems using the Master-Slave prediction structure.

### BACKGROUND AND RELATED ART

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC, VP8, VP9 and the emerging HEVC (High Efficiency Video Coding) standard. In order to maintain manageable complexity, an image is often divided into blocks, such as macroblock (MB) or coding unit (CU) to apply video coding. Video coding standards usually adopt adaptive Inter/Intra prediction on a block basis.

FIG. 1A illustrates an exemplary adaptive Inter/Intra video coding system incorporating loop processing. For Inter-prediction, Motion Estimation 112 and Motion Compensation 113 are used to provide prediction data for input picture 111 based on video data from other picture or pictures. Switch 114 selects Intra Prediction or Inter prediction data and the selected prediction data is supplied to Adder 116 to form prediction errors, also called residues. When Intra prediction is selected, Intra prediction decision unit 115 will select an Intra mode from a set of Intra modes. Intra predictor will be generated by the Intra prediction unit 117. The prediction error is then processed by Transform (T) 118 followed by Quantization (Q) 120. The transformed and quantized residues are then coded by Entropy Encoder 122 to be included in a video bitstream corresponding to the compressed video data. When an Inter-prediction mode is used, a reference picture or pictures have to be reconstructed at the encoder end and will be used as reference data for one or more other pictures. Consequently, decoding function is also included in the encoder side as indicated by the dash-lined box 140, where the transformed and quantized residues are processed by Inverse Quantization (IQ) 124 and Inverse Transformation (IT) 126 to recover the residues. The residues are then added back to prediction data 136 using adder 128 to reconstruct video data. The reconstructed video data is processed by loop filter 130 to reduce coding artifacts in the reconstructed data before the reconstructed data are stored in Decoded Picture Buffer (DPB) 134 and used for prediction of other pictures.

FIG. 1B illustrates an exemplary system block diagram for a video decoder based on adaptive Inter/Intra prediction. At the decoder side, the video bitstream 150 is first processed by entropy decoding unit 152 to recover coded symbols. The reconstructed and loop filtered pictures stored in the DPB 134 will be outputted for display 154.

For an adaptive Inter/Intra prediction video coding system, some pictures are coded in the Intra prediction mode for various reasons. For example, Intra prediction mode may be used periodically to alleviate error propagation due to transmission or decoding errors for pictures coded in the Inter prediction mode. For Intra coded pictures, it usually results in much higher bitrate. For Inter prediction, each picture may be coded as a P-picture or B-picture. For a P-picture, the coded picture may be used by previous pictures as a reference picture. On the other hand, a B-picture may not be referenced by any other pictures for the coding purpose.

The video coding based on adaptive Inter/Intra prediction can be applied to conventional video data at various resolutions. In recent years, 360-degree video for Virtual Reality (VR) applications is becoming a new type of video source to be encoded. The 360-degree VP video involves the capturing a scene using multiple cameras to cover a panoramic view, such as 360-degree field of view. The 360-degree VP camera usually uses a set of cameras, arranged to capture 360-degree field of view. Nevertheless, typically two or more cameras are used for the immersive camera. At each captured time instant, the 360-degree environment is captured by multiple cameras and stored by multiple images. Then, those images at the same captured time instant are stitched to form an extremely high resolution of 360-degree VR image at each time instant. The successive 360-degree VR images are thus collected to become a 360-degree VR video. For 360-degree VR video, the large amount of video data needs to be compressed for efficient transmission or storage. Accordingly, high efficiency video coding techniques such as HEVC have been used for VR video compression. Typically, with similar encoding quality, the coding bitrate is proportional to the picture resolution. Thus, encoding an extremely high resolution of 360-degree VR video results in a high bitrate of video bitstream with acceptable visual quality. With the trend of ever increasing picture resolution, the high efficiency coding techniques are very desirable to keep the rate of video bitstream tractable. Furthermore, when high resolution is used with 360-degree VR video, the bitrate becomes even more an issue for transmission or storage due to the large amount of data generated. Consequently, high efficiency video coding is highly desirable for the 360-degree VR applications.

### BRIEF SUMMARY OF THE INVENTION

A method and apparatus of video coding using Inter coding mode with Master-Slave prediction structure are disclosed. At the encoder side, if the current input picture is designated as a master picture, the current input picture is down-sampled to a current down-sampled picture and the current down-sampled picture is encoded using an Intra mode or an Inter mode. When a block of the current down-sampled picture is Inter-coded, this block only uses one or more previous reconstructed down-sampled pictures as one or more first reference pictures. If the current input picture is designated as a slave picture, the reference pictures should be modified by up-sampling one or more previous reconstructed down-sampled pictures. Therefore, an Inter-coded block of a slave picture only uses one or more modified reference pictures (up-sampled pictures) corresponding to said one or more up-sampled pictures as one or more second reference pictures. For example, a master picture may be encoded in the Inter mode as a B-picture and referenced by at least one slave picture.

At the decoder side, if the current input picture is designated as a master picture, a current reconstructed down-sampled picture is reconstructed from the video bitstream. The current reconstructed down-sampled picture is reconstructed using one or more previous reconstructed down-sampled pictures as one or more first reference pictures if a block of the current reconstructed down-sampled picture is Inter-coded. If the current input picture is designated as a slave picture, the reference blocks for an Inter-coded block of the current input picture are generated by only using pixel data from one or more areas in one or more up-sampled pictures generated by up-sampling said one or more previous reconstructed down-sampled pictures, wherein said one or more areas are smaller than or equal to said one or more up-sampled pictures.

Each down-sampled picture is always used by at least one slave picture as reference picture for encoding. A reconstructed picture corresponding to the current input picture designated as the slave picture is not used as any reference picture for encoding. Only reconstructed down-sampled pictures and up-sampled pictures are stored in decoded picture buffers and no reconstructed slave pictures are stored in the decoded picture buffers. Down-sampling the current input picture may use a horizontal down-sampling factor and a vertical down-sampling factor.

Encoding and decoding the current input picture may comprise selecting a candidate motion vector associated with a co-located block in first previous reconstructed down-sampled picture in a first list for a current block. A forward motion vector and a backward motion vector are derived by scaling the candidate motion vector. A first reference block in a first up-sampled picture of the second previous reconstructed down-sampled picture in the second list using the forward motion vector and a second reference block in a second up-sampled picture of the first previous reconstructed down-sampled picture in the first list using the backward motion vector are located. The current block is coded in a bi-prediction mode using the first reference block as a forward predictor and using the second reference block as a backward predictor. The candidate motion vector is pointing from a corresponding block in second previous reconstructed down-sampled picture in a second list to the co-located block, and wherein the first list and the second list correspond to two different lists belonging to a set consisting of List 0 and List 1. The forward motion vector can be derived by scaling the candidate motion vector with a first scaling factor corresponding to a first ratio of a first distance and a second distance, where the first distance corresponds to a first difference between picture order count (POC) of the current input picture and POC of the second previous reconstructed down-sampled picture in the second list. The second distance corresponds to a second difference between POC of the first previous reconstructed down-sampled picture in the first list and POC of the second previous reconstructed down-sampled picture in the second list. The backward motion vector is derived by scaling the candidate motion vector with a second scaling factor corresponding to a second ratio of a third distance and the second distance, where the third distance corresponds to a third difference between POC of the current input picture and POC of the first previous reconstructed down-sampled picture in the first list. When a current block in the current input picture inherits a target motion vector associated with a co-located block in a previous reconstructed down-sampled picture, all blocks co-located with an up-sampled block of the located block share the target motion vector.

Picture reconstruction using a reconstruction unit in an encoder side can be skipped for the slave picture and is applied only to the master picture. A bitstream associated one or more slave pictures can be partially transmitted upon an indication from a decoder side. The slave picture can be partially decoded.

### BRIEF DESCRIPTION OF THE DRAWINGS

FIG. 1A illustrates an exemplary system block diagram for an adaptive Inter/Intra video encoder.

FIG. 1B illustrates an exemplary system block diagram for a video decoder based on adaptive Inter/Intra prediction.

FIG. 2 illustrates an example of Master-Slave prediction structure for a video coding system using Inter/Intra prediction.

FIG. 3 illustrates an example of low-complexity master-slave prediction structure with spatial resizing according to an embodiment of the present invention.

FIG. 4 illustrates an example of low-complexity master-slave prediction structure with spatial resizing according to another embodiment of the present invention.

FIG. 5A illustrates an exemplary adaptive Inter/Intra video encoder incorporating low-complexity prediction structure according to one embodiment of the present invention.

FIG. 5B illustrates an exemplary adaptive Inter/Intra video decoder incorporating low-complexity prediction structure according to one embodiment of the present invention.

FIG. 6 illustrates an example of Motion Vector Prediction (MVP) derivation for a system using low-complexity prediction structure according to one embodiment of the present invention.

FIG. 7 illustrates an exemplary flowchart for a video encoder incorporating low-complexity prediction structure according to one embodiment of the present invention.

FIG. 8 illustrates an exemplary flowchart for a video decoder incorporating low-complexity prediction structure according to one embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

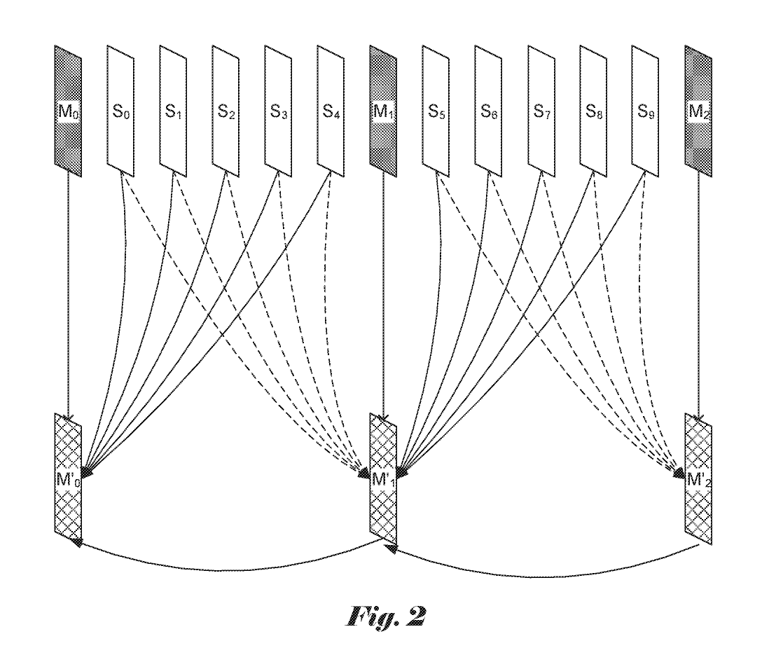

FIG. 2 illustrates an example of Master-Slave prediction structure for a video coding system using Inter/Intra prediction. The pictures to be coded in display order are M₀, S₀, . . . , S₄, M₁, S₅, . . . , S₉, and M₂. Picture M₀ is Intra coded. Picture M₁ corresponds to a P-picture using M₀ as a reference picture. Picture M₂ corresponds to a P-picture using M₁ as a reference picture. On the other hand, pictures S₀, . . . , S₄ are B-pictured using M₀ and M₁ as reference pictures. Pictures S₅, . . . , S₅ are B-pictured using M₁ and M₂ as reference pictures. Pictures that are referenced by one or more other pictures are called master pictures and pictures that are not referenced by any other picture are called slave pictures in this disclosure. For example, in FIG. 2, pictures M₀, M₁ and M₂ are master pictures and pictures S₀, . . . , S₉ are slave pictures.

Since a master picture will be used by one or more other pictures as a reference picture, the master pictures have to be stored in the encoder and decoder so that they can be used as reference pictures by other pictures. In the example shown in FIG. 2, pictures M₀, and M₁ have to be stored for encoding and decoding of pictures S₀, . . . , S₄. After S₀, . . . , S₄ are encoded or decoded, picture M₀ can be removed from the DPB. Therefore, two decoded pictures have to be stored in the DPB. For high-resolution pictures, the size of a master picture may be very large. Not only it requires large-size decoded picture buffers to stored reference pictures, but also it requires more coding bits during encoding and more computations during decoding. It is desirable to develop technique to reduce the coding bitrate and the required computational processing power.

As mentioned above, the master-slave prediction structure as shown in FIG. 2 is focused on the complexity and bit-rate reduction of the slave pictures. For the slave pictures, the complexity is reduced by more than 50%. Also, the bit-rate is reduced by about 50% if slave pictures are partially sent. In the aforementioned approach, the master pictures are always coded in full resolution in the encoder side and decoded in full resolution at the decoder side. Therefore, the complexity and the associated bit-rate are rather high for the master pictures. Accordingly, a low-complexity master-slave prediction structure with spatial resizing is disclosed in the present invention. Embodiments of the present invention encode a down-sampled version of the master pictures to achieve low bit-rate transmission as well as low-complexity processing since the master pictures are coded in down-sampled version. However, the up-sampled reconstruction master pictures are used as the reference pictures for Inter prediction of the slave pictures and used for display as well.

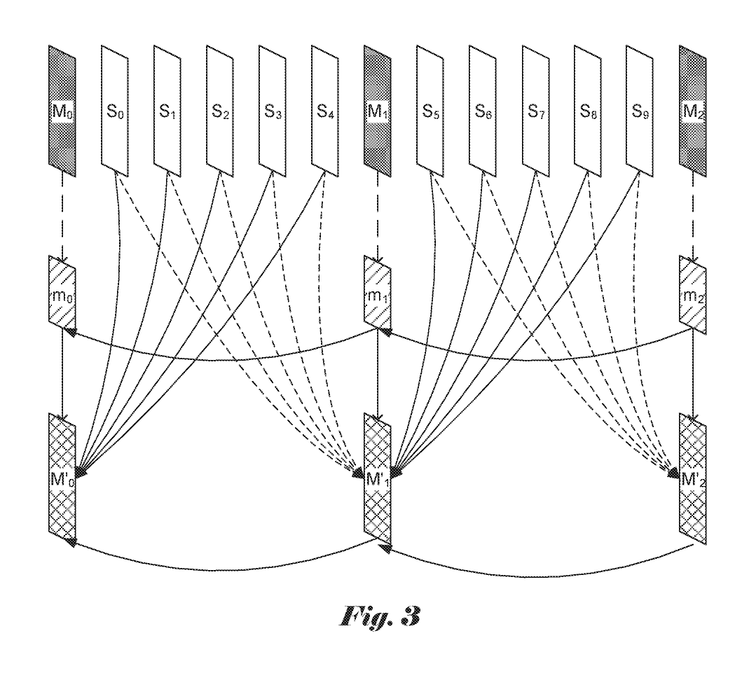

FIG. 3 illustrates an example of low-complexity master-slave prediction structure with spatial resizing according to embodiments of the present invention. The picture presentation order for the video source is M₀, S₀, . . . , S₄, M₁, S₅, . . . , S₉ and M₂. According to an embodiment of the present invention, the master pictures are down-sampled and encoded. The encoding order for this example is m₀, m₁, S₀, . . . , S₄, m₂, S₅, . . . , S₉, where m₀, m₁, and m₂ are the down-sampled version of M₀, M₁, and M₂ respectively. After down-sampling, the down-sampled pictures m₀, m₁, and m₂ are encoded. The example in FIG. 3 shows down-sampled picture m₀ is Intra coded while down-sampled picture m₁ is coded as a P-picture using down-sampled picture m₀ as a reference picture, and m₂ is coded as a P-picture using down-sampled picture m₁ as a reference picture. For encoding the slave pictures, the coded down-sampled master pictures are up-sampled to the full-size pictures (i.e., M′₀, M′₁ and M′₂) and then used as reference pictures by the slave pictures. In one embodiment, the slave picture coding may generate one or more reference blocks for an Inter-coded block of the slave picture by only using pixel data from one or more areas in one or more up-sampled pictures generated. The one or more areas can be smaller than or equal to the one or more up-sampled pictures. Slave pictures S₀, . . . , S₄ use M′₀ and M′₁ as reference pictures, where picture M′₀ is used for forward prediction and picture M′₁ is used for backward prediction. The decoding order is the same as the encoding order. Similarly, slave pictures S₅, . . . , S₉ use pictures M′₁ and M′₂ as reference pictures, where picture M′₁ is used for forward prediction and picture M′₂ is used for backward prediction. The display order for decoded pictures is M′₀, S₀, . . . , S₄, M′₁, S₅, . . . , S₉ and M′₂.

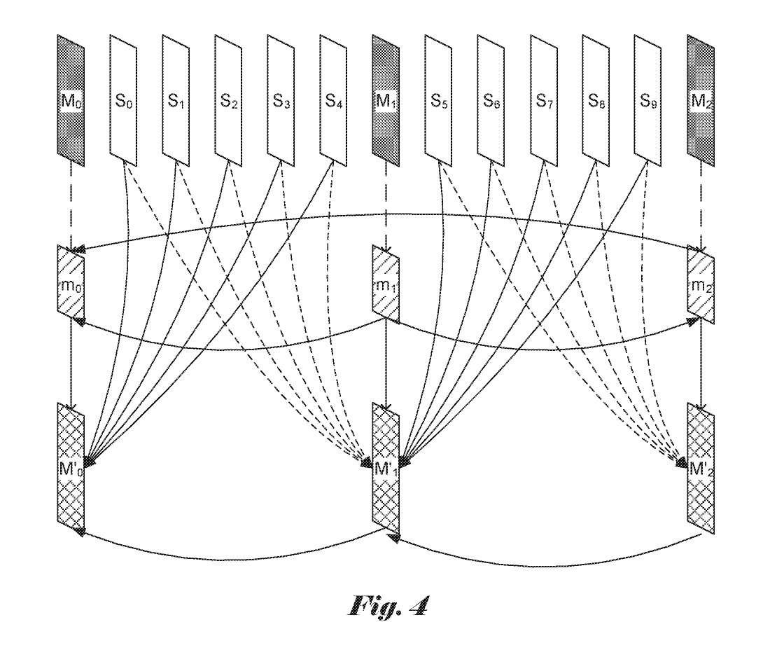

FIG. 4 illustrates an example of low-complexity master-slave prediction structure with spatial resizing according to another embodiment of the present invention. The example in FIG. 4 shows down-sampled picture m₀ is Intra coded, down-sampled picture m₂ is coded as a P-picture using down-sampled picture m₀ as a reference pictures, and m₁ is coded as a B-picture using m₀ and m₂ as reference pictures. For encoding the slave pictures, the coded down-sampled master pictures are up-sampled to the full-size pictures (i.e., M′₀, M′₁ and M′₂) and then used as reference pictures by the slave pictures. Slave pictures S₀, . . . , S₄ still use M′₀ and M′₁ as reference pictures. Similarly, slave pictures S₅, . . . , S₉ still use pictures M′₁ and M′₂ as reference pictures. However, since M₁ is coded after M₂ in this example, the encoding order for the master pictures has to be modified. Accordingly, the encoding order is m₀, m₂, m₁, S₀, . . . , S₄ and S₅, . . . , S₉. The display order for decoded pictures is the same as before, i.e., M′₀, S₀, . . . , S₄, M′₁, S₅, . . . , S₉ and M′₂.

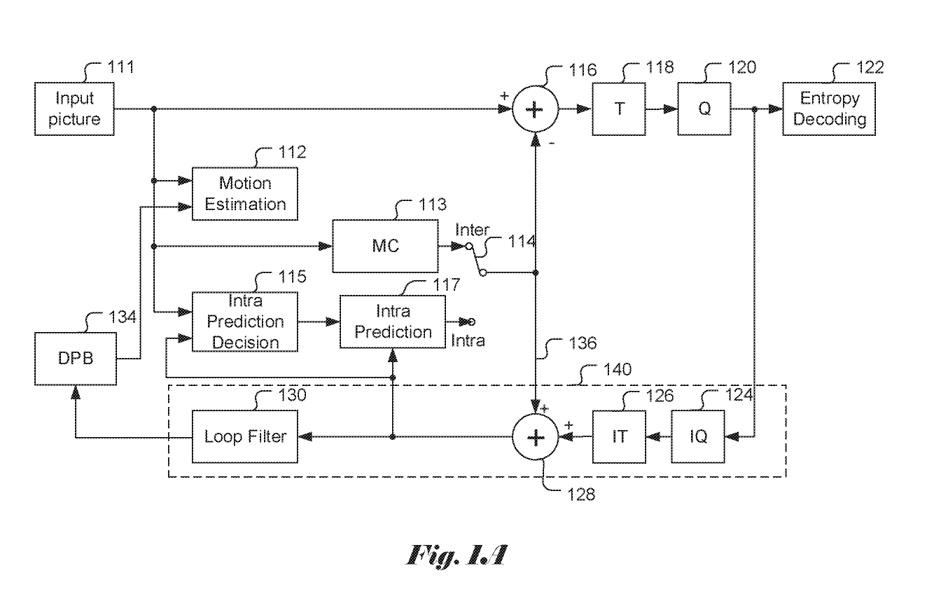

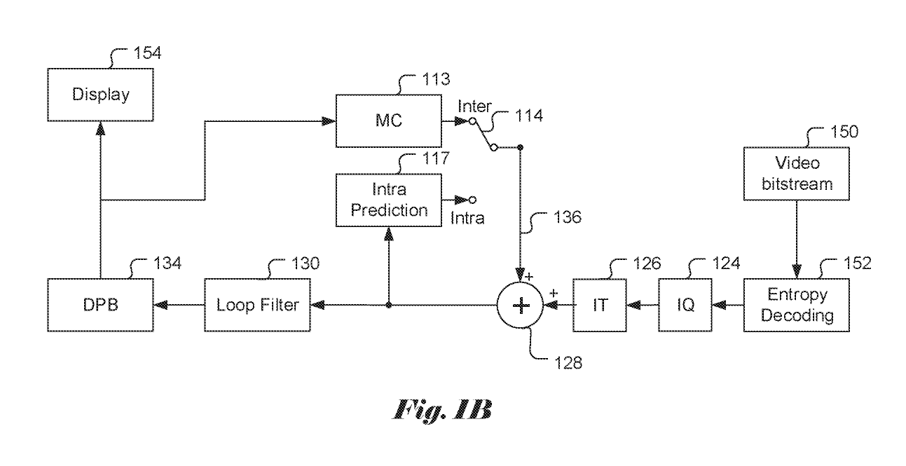

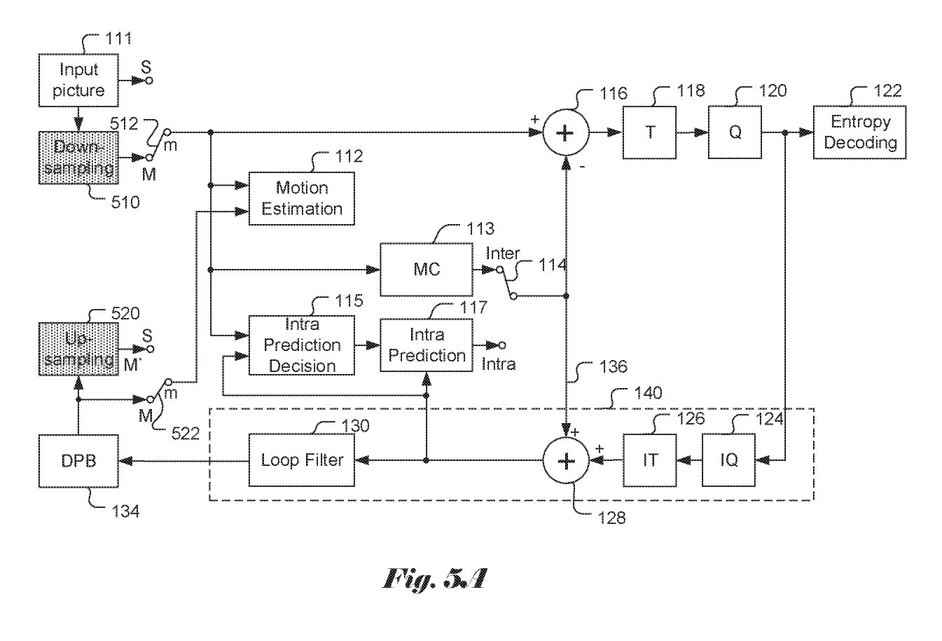

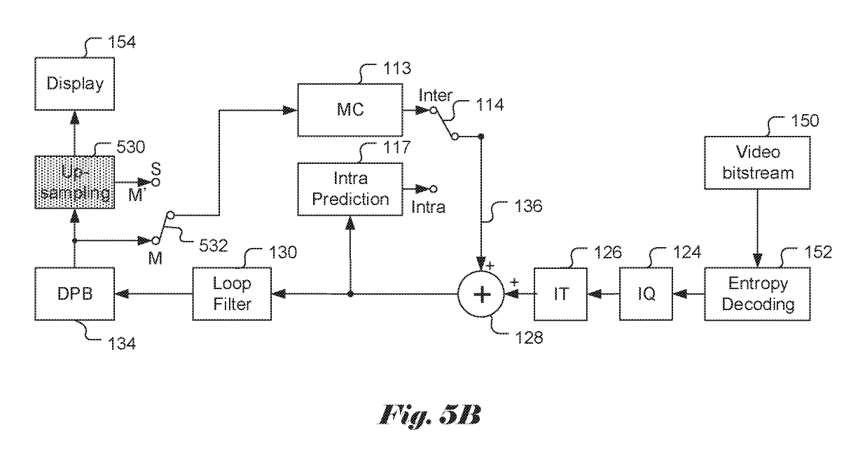

FIG. 5A illustrates an example of video coding system incorporating low-complexity master-slave prediction structure according to an embodiment of the present invention. The system is based on the encoder in FIG. 1A. A down-sampling unit 510 is added to the encoding section to perform down sampling on the master pictures when a master picture is encoded. Switch 512 is used to select between a slave picture (i.e., position “5”) and a master picture (i.e., position “M”). When switch 512 is at “M” position, the down-sampled master picture (i.e., “m”) is provided to the encoder input. When switch 512 is at “S” position, the original slave picture is provided to the encoder input. In the reconstruction loop, the reconstructed down-sampled master picture m is stored in decoder picture buffer (DPB) 134. When the currently coded picture corresponds to a master picture, switch 522 is set to position “M” so that one or more down-sampled master pictures are retrieved from DPB 134 and used as reference pictures. When the currently coded picture corresponds to a slave picture, switch 522 is set to position “5” so that one or more down-sampled master pictures are retrieved from DPB 134 and then up-sampled using up-sampling unit 520 before the down-sampled master pictures are used as reference pictures.

For master-picture encoding, the pictures can be encoded as I/P/B-pictures and used as reference pictures for slave-picture encoding. For the down-sampling performed by down-sampling unit 510, down-sampling ratios d_{W} and d_{H} in the picture width (i.e., horizontal) direction and the picture height (i.e., vertical) direction can be selected. For example, both d_{W} and d_{H} can be 2 for 2:1 down sampling in the horizontal and vertical directions. Nevertheless, different down-sampling ratios in the horizontal and vertical directions may be used as well. The encoding for down-sampled master pictures (i.e., picture m) will only use down-sampled master pictures (i.e., m pictures) as reference pictures. For salve-picture encoding, the reconstructed down-sampled master pictures (i.e., m pictures) are up-sampled to full-resolution pictures (i.e., M′ pictures) and used as reference pictures. Accordingly, both reconstructed m pictures and up-sampled M′ pictures have to be stored in the DPB 134. In other words, storage space for up-sampled M′ pictures will be needed, which is not explicitly shown in FIG. 5A. The original DPB 134, the up-sampling unit 520 along with the required storage space for up-sampled M′ pictures can be considered as a modified DPB according to embodiments of the present invention.

For slave-picture encoding, the slave pictures can be coded as I/PM-pictures, but not referenced by any other picture. At the encoder side, there is no need for reconstructing slave pictures since none of the reconstructed slave pictures are used as reference picture by other pictures. There is no need for storing the reconstructed slave pictures in the DPB 134 either.

FIG. 5B illustrates an example of video decoding system incorporating low-complexity master-slave prediction structure according to an embodiment of the present invention. The system is based on the encoder in FIG. 1B. When the currently coded picture corresponds to a master picture, switch 532 is set to position “M” so that one or more down-sampled master pictures are retrieved from DPB 134 and used as reference pictures. When the currently coded picture corresponds to a slave picture, switch 532 is set to position “S” so that one or more down-sampled master pictures are retrieved from DPB 134 and up-sampled using up-sampling unit 530 before the down-sampled master pictures are used as reference pictures.

For the decoder, the original DPB 134, the up-sampling unit 530 along with the required storage space for up-sampled M′ pictures can be considered as a modified DPB according to embodiments of the present invention. For master picture decoding, the decoding process always uses the fully transmitted bitstream and the master pictures are always fully decoded. Also, the reconstructed down-sampled pictures (i.e., m pictures) are up-sampled and stored in the DPB as reference pictures used by slave pictures. Also, the up-sampled pictures (i.e., M pictures) are outputted for display.

For slave-picture decoding, partial bitstream may be transmitted and used for decoding. For 360-degree VR applications, a user may indicate to the data server (such as encoder) regarding the portion of pictures (such as viewport region) to be viewed so that the data server will only transmit a partial bitstream associated with the viewport region. Also, the slave pictures may be partially decoded for the viewport region. As mentioned before, the slave pictures are decoded using up-sampled M′ pictures as reference pictures.

When motion vector prediction (MVP) is used for the slave pictures, the spatial resolution of the slave pictures and the spatial resolution associated with the pictures (i.e., m pictures) used to derive the motion vector is different. Therefore, the correspondence between blocks of the down-sampled pictures and the blocks of the slave pictures has to be taken care of.

MVP is a known coding tool widely used in many advanced coding standards such as H.264 and HEVC (high efficiency video coding). In order to reduce bitrate associated with encoding the motion vector of a current block, motion vector prediction, also abbreviated as MVP, is used to derive a motion vector predictor used by a current coding block. A MVP candidate list is generated from spatial and/or temporal neighboring blocks for Inter prediction mode, and Skip/Direct (also called Merge) modes. For Inter prediction mode, one or two the motion vector differences (MVDs) between current MV(s) and MVP(s) are transmitted/coded, which is more efficient than encoding the current MV(s) directly due to correlation between the current MV(s) and MVP(s). The prediction residuals between the current block and the reference block(s) are also transmitted/coded for the Inter prediction mode. For Skip/Merge modes, the motion information is inherited from a neighboring block. For the Merge mode, the prediction residuals are transmitted. However, for the Skip mode, the prediction residuals are not transmitted and are set to zero. For Skip mode, the residuals are usually very small so that the residuals can be skipped.

For a coding system incorporating low-complexity prediction structure, the MVP may have to be modified. For example, there is no need to modify the MVP derivation when a Skip mode (at a P-type master picture, as shown in FIG. 3) is used in the H.264 coding standard. Moreover, Direct mode used in B picture has two types, including Spatial Direct mode and Temporal Direct mode. For the Spatial Direct mode, there is no need to modify the MVP because the MVP is obtained from its spatial neighboring blocks. When the Temporal Direct mode is used, the MVP has to be modified because the MVP is determined from a co-located temporal neighboring block. If the motion vector of co-located temporal neighboring block, MV_{List1}^{co-located} points to a reference picture in List 1, the forward (MV_{forward}) and backward MVP (MV_{backward}) are modified according to the picture distances as follows:

$$\begin{matrix}{MV}_{forward} = \frac{{MV}_{List 1}^{co - located} \times ( {POC}^{cur} - {POC}^{List 0} )}{\vert {POC}^{List 1} - {POC}^{List 0} \vert} , and & ( 1 ) \\ {MV}_{backward} = \frac{{MV}_{List 1}^{co - located} \times ( {POC}^{cur} - {POC}^{List 1} )}{\vert {POC}^{List 1} - {POC}^{List 0} \vert} . & ( 2 )\end{matrix}$$

In the above equation, POC^{cur} corresponds to the picture order count of the current picture, POC^{List0} corresponds to the picture order count of the List-0 reference picture and POC^{List1} corresponds to the picture order count of the List-1reference picture.

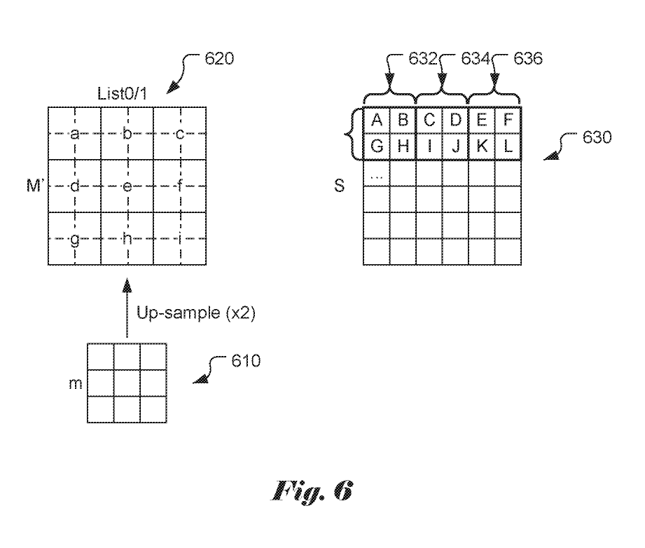

FIG. 6 illustrates an example of modified MVP derivation, where the down-sampling factor is 2 in both the horizontal and vertical directions. Blocks of the reconstructed m picture 610 is up-sampled by a factor-of-2 up-sampling to form blocks of the M′ picture 620. The up-sampled blocks of the M′ picture 620 is then used as reference blocks for encoding or decoding blocks of the slave picture 630. As shown in FIG. 6, each block in picture m covers four blocks in the up-sampled picture M′. Therefore, the co-located block of blocks A, B, G and H at the slave picture block a, the co-located block of blocks C, D, I and J at the slave picture are block b, and the co-located block of blocks E, F, K and L at the slave picture are block c. That is, four neighboring blocks of a slave picture have the same co-located block of a master picture. The MVP derivation as shown in equations (1) and (2) is applied to all corresponding co-located blocks for each block in picture m. For example, the motion vector for block a (i.e., the co-located block at reference picture List 1) is used for derivation of forward and backward motion vector predictors for blocks A, B, G and H.

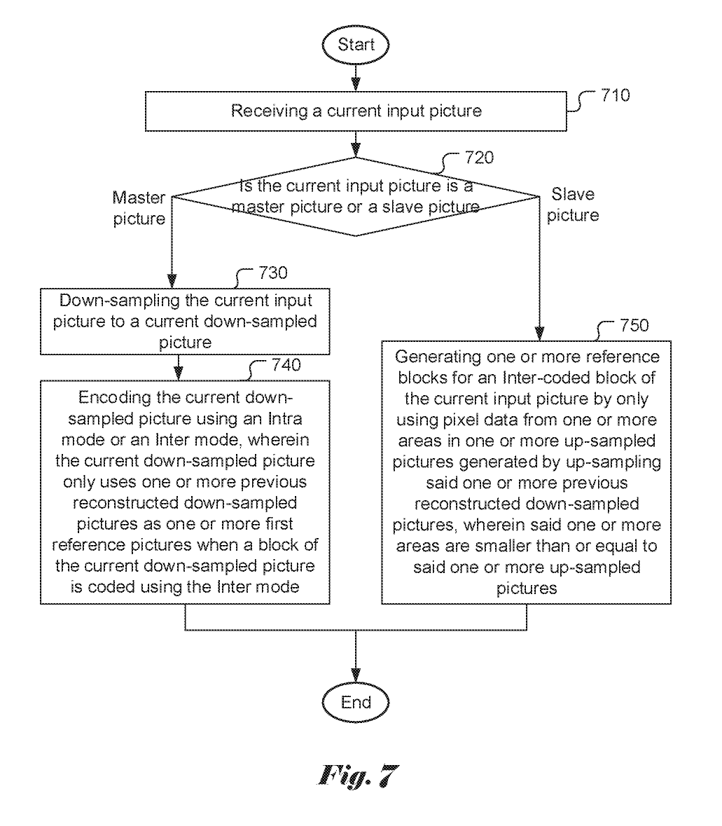

FIG. 7 illustrates an exemplary flowchart for a video encoder incorporating low-complexity prediction structure according to one embodiment of the present invention. According to this method, a current input picture is received in step 710. A decision regarding whether the current input picture is designated as a master picture or a slave picture is performed in step 720. The designating picture types (i.e., master or slave picture, and I-, P- or B-picture) usually is a function for the encoder. The encoder may designate master/slave pictures according to a pre-defined order or any other known method. If the current input picture is designated as a master picture, steps 730 and 740 are performed. If the current input picture is designated as a slave picture, step 750 is performed. In step 730, the current input picture is down-sampled to a current down-sampled picture (i.e., picture m). In step 740, the current down-sampled picture is encoded using an Intra mode or an Inter mode, where the current down-sampled picture only uses one or more previous reconstructed down-sampled pictures as one or more first reference pictures when a block of the current down-sampled picture is Inter-coded. In step 750, one or more reference blocks for an Inter-coded block of the current input picture are generated by only using pixel data from one or more areas in one or more up-sampled pictures generated by up-sampling said one or more previous reconstructed down-sampled pictures, where said one or more areas are smaller than or equal to said one or more up-sampled pictures.

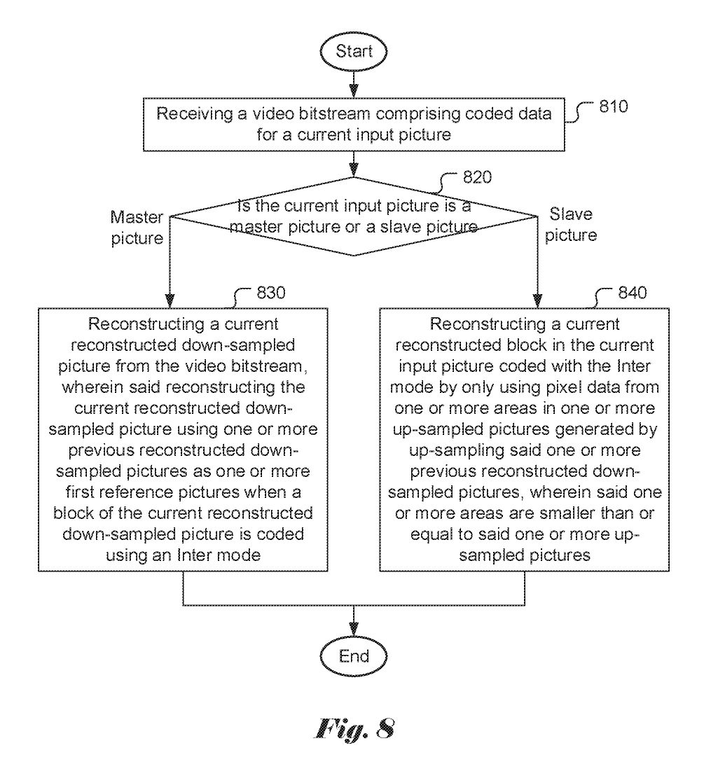

FIG. 8 illustrates an exemplary flowchart for a video decoder incorporating low-complexity prediction structure according to one embodiment of the present invention. According to this method, a video bitstream comprising coded data for a current input picture is received in step 810. A decision regarding whether the current input picture is designated as a master picture or a slave picture is performed in step 820. In some cases, the decoder may be able to determine whether it is a master picture or slave picture according to a pre-defined order. In other cases, the decoder may determine whether the current input picture is designated as a master picture or a slave picture according to information in the bitstream. If the current input picture is designated as a master picture, step 830 is performed. If the current input picture is designated as a slave picture, step 840 is performed. In step 830, a current reconstructed down-sampled picture is reconstructed from the video bitstream, where said reconstructing the current reconstructed down-sampled picture using one or more previous reconstructed down-sampled pictures as one or more first reference pictures when a block of the current reconstructed down-sampled picture is Inter-coded. In step 840, the current reconstructed block in the current input picture coded with the Inter mode is reconstructed by only using pixel data from one or more areas in one or more up-sampled pictures generated by up-sampling said one or more previous reconstructed down-sampled pictures, where said one or more areas are smaller than or equal to said one or more up-sampled pictures.

The flowchart shown above is intended to illustrate examples of video coding incorporating an embodiment of the present invention. A person skilled in the art may modify each step, re-arranges the steps, split a step, or combine the steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video encoding using Inter coding mode with Master-Slave prediction structure, the method comprising:
receiving a current input picture;
if the current input picture is designated as a master picture:
down-sampling the current input picture to a current down-sampled picture; and
encoding the current down-sampled picture using an Intra mode or an Inter mode, wherein the current down-sampled picture only uses one or more previous reconstructed down-sampled pictures as one or more first reference pictures when a block of the current down-sampled picture is coded using the Inter mode; and
if the current input picture is designated as a slave picture:
generating one or more reference blocks for an Inter-coded block of the current input picture by only using pixel data from one or more areas in one or more up-sampled pictures generated by up-sampling said one or more previous reconstructed down-sampled pictures, wherein said one or more areas are smaller than or equal to said one or more up-sampled pictures.

2. The method of claim 1, wherein a down-sampled picture is used by at least one slave picture as one second reference picture for encoding.

3. The method of claim 1, wherein a reconstructed picture corresponding to the current input picture designated as the slave picture is not used as any reference picture for encoding.

4. The method of claim 1, wherein only reconstructed down-sampled pictures and said one or more up-sampled pictures are stored in decoded picture buffers and no reconstructed slave picture is stored in the decoded picture buffers.

5. The method of claim 1, wherein said down-sampling the current input picture uses a horizontal down-sampling factor and a vertical down-sampling factor.

6. The method of claim 1, wherein said encoding the current input picture comprising:
selecting a candidate motion vector associated with a co-located block in first previous reconstructed down-sampled picture in a first list for a current block, wherein the candidate motion vector is pointing from a corresponding block in second previous reconstructed down-sampled picture in a second list to the co-located block, and wherein the first list and the second list correspond to two different lists belonging to a set consisting of List 0 and List 1;
deriving a forward motion vector and a backward motion vector by scaling the candidate motion vector;
locating a first reference block in a first up-sampled picture of the second previous reconstructed down-sampled picture in the second list using the forward motion vector and locating a second reference block in a second up-sampled picture of the first previous reconstructed down-sampled picture in the first list using the backward motion vector; and
encoding the current block in a bi-prediction mode using the first reference block as a forward predictor and using the second reference block as a backward predictor.

7. The method of claim 6, wherein the forward motion vector is derived by scaling the candidate motion vector with a first scaling factor corresponding to a first ratio of a first distance and a second distance, wherein the first distance corresponds to a first difference between picture order count (POC) of the current input picture and POC of the second previous reconstructed down-sampled picture in the second list, and the second distance corresponds to a second difference between POC of the first previous reconstructed down-sampled picture in the first list and POC of the second previous reconstructed down-sampled picture in the second list; and
the backward motion vector is derived by scaling the candidate motion vector with a second scaling factor corresponding to a second ratio of a third distance and the second distance, wherein the third distance corresponds to a third difference between POC of the current input picture and POC of the first previous reconstructed down-sampled picture in the first list.

8. The method of claim 1, wherein when a current block in the current input picture inherits a target motion vector associated with a co-located block in a previous reconstructed down-sampled picture, all blocks co-located with an up-sampled block of the co-located block share the target motion vector.

9. The method of claim 1, wherein picture reconstruction using a reconstruction unit in an encoder side is skipped for the slave picture and is applied only to the master picture.

10. The method of claim 1, wherein a given master picture is coded in the Inter mode as one B-picture and the given master picture is referenced by at least one slave picture.

11. An apparatus for of video encoding using Inter coding mode with Master-Slave prediction structure, the apparatus comprising one or more electronic circuits or processors configured to:
receive a current input picture;
if the current input picture is designated as a master picture:
down-sample the current input picture to a current down-sampled picture; and
encoding the current down-sampled picture using an Intra mode or an Inter mode, wherein the current down-sampled picture only uses one or more previous reconstructed down-sampled pictures as one or more first reference pictures when a block of the current down-sampled picture is coded using the Inter mode; and
if the current input picture is designated as a slave picture:
generate one or more reference blocks for an Inter-coded block of the current input picture by only using pixel data from one or more areas in one or more up-sampled pictures generated by up-sampling said one or more previous reconstructed down-sampled pictures, wherein said one or more areas are smaller than or equal to said one or more up-sampled pictures.

12. A method of video decoding using Inter coding mode with Master-Slave prediction structure, the method comprising:
receiving a video bitstream comprising coded data for a current input picture;
if the current input picture is designated as a master picture:
reconstructing a current reconstructed down-sampled picture from the video bitstream, wherein said reconstructing the current reconstructed down-sampled picture using one or more previous reconstructed down-sampled pictures as one or more first reference pictures when a block of the current reconstructed down-sampled picture is coded using an Inter mode; and
if the current input picture is designated as a slave picture:
reconstructing a current reconstructed block in the current input picture coded with the Inter mode by only using pixel data from one or more areas in one or more up-sampled pictures generated by up-sampling said one or more previous reconstructed down-sampled pictures, wherein said one or more areas are smaller than or equal to said one or more up-sampled pictures.

13. The method of claim 12, wherein an down-sampled picture is used by at least one slave picture as one second reference picture for decoding.

14. The method of claim 12, wherein a reconstructed picture corresponding to the current input picture designated as the slave picture is not used as any reference picture for decoding.

15. The method of claim 12, wherein for master picture decoding, reconstructed down-sampled pictures and said one or more up-sampled pictures are stored in decoded picture buffers.

16. The method of claim 12, wherein said down-sampling the current input picture uses a horizontal down-sampling factor and a vertical down-sampling factor.

17. The method of claim 12, wherein said reconstructing the current reconstructed block comprising:
determining a candidate motion vector associated with a co-located block in first previous reconstructed down-sampled picture in a first list for a current block, wherein the candidate motion vector is pointing from a corresponding block in second previous reconstructed down-sampled picture in a second list to the co-located block, and wherein the first list and the second list correspond to two different lists belonging to a set consisting of List 0 and List 1;
deriving a forward motion vector and a backward motion vector by scaling the candidate motion vector;
locating a first reference block in a first up-sampled picture of the second previous reconstructed down-sampled picture in the second list using the forward motion vector and locating a second reference block in a second up-sampled picture of the first previous reconstructed down-sampled picture in the first list using the backward motion vector; and
decoding the current block in a bi-prediction mode using the first reference block as a forward predictor and using the second reference block as a backward predictor.

18. The method of claim 17, wherein the forward motion vector is derived by scaling the candidate motion vector with a first scaling factor corresponding to a first ratio of a first distance and a second distance, wherein the first distance corresponds to a first difference between picture order count (POC) of the current input picture and POC of the second previous reconstructed down-sampled picture in the second list, and the second distance corresponds to a second difference between POC of the first previous reconstructed down-sampled picture in the first list and POC of the second previous reconstructed down-sampled picture in the second list; and
the backward motion vector is derived by scaling the candidate motion vector with a second scaling factor corresponding to a second ratio of a third distance and the second distance, wherein the third distance corresponds to a third difference between POC of the current input picture and POC of the first previous reconstructed down-sampled picture in the first list.

19. The method of claim 12, wherein when a current block in the current input picture inherits a target motion vector associated with a co-located block in a previous reconstructed down-sampled picture, all blocks co-located with an up-sampled block of the co-located block share the target motion vector.

20. The method of claim 12, wherein a bitstream associated one or more slave pictures is only partially transmitted to a decoder side upon an indication from the decoder side.

21. The method of claim 12, wherein the slave picture is only partially reconstructed, wherein only a portion of the slave picture to be viewed by a user is reconstructed.

22. The method of claim 12, wherein a given master picture is coded in the Inter mode as one B-picture and the given master picture is referenced by at least one slave picture.

23. An apparatus for video decoding using Inter coding mode with Master-Slave prediction structure, the apparatus comprising one or more electronic circuits or processors configured to:
receive a video bitstream comprises coded data for a current input picture;
if the current input picture is designated as a master picture:
reconstruct a current reconstructed down-sampled picture from the video bitstream, using one or more previous reconstructed down-sampled pictures as one or more first reference pictures when a block of the current reconstructed down-sampled picture is coded using an Inter mode; and
if the current input picture is designated as a slave picture:
reconstruct a current reconstructed block in the current input picture coded with the Inter mode by only using pixel data from one or more areas in one or more up-sampled pictures generated by up-sampling said one or more previous reconstructed down-sampled pictures, wherein said one or more areas are smaller than or equal to said one or more up-sampled pictures.
